(19) United States
(12) Patent Application Publication
(10) Pub. No.: US 2023/0219246 A1
(43) Pub. Date: Jul. 13, 2023

(54) MAGNETIC SUSPENSION SHAVER HEAD STRUCTURE

(71) Applicants: Ningbo Jibeibei Technology Co., Ltd., Ningbo City (CN); Zhejiang Xiaowo Intelligent Technology Co., Ltd., Ningbo City (CN)

(72) Inventors: Hongxia Xiang, Ningbo City (CN); Yuye Cai, Ningbo City (CN)

(21) Appl. No.: 17/749,103

(22) Filed: May 19, 2022

(30) Foreign Application Priority Data
Jan. 11, 2022 (CN) 202220057483.9

(51) Int. Cl. B26B 19/38

(52) U.S. Cl. CPC B26B 19/386

(57) ABSTRACT

The present disclosure relates to a magnetic suspension shaver head structure, including: a static cutter head and a shaver body, the upper surface of the shaver body is provided with a positioning slot, the inner wall of the positioning slot is provided with a strong magnetic positioning frame, the two opposite sides of the strong magnetic positioning frame are open with mounting port, and the inner wall of the mounting port is fixedly connected with a suspended strong magnet, the upper surface of the static cutter head is provided with a movable cutter head, the top side of the movable cutter head is fixedly connected with a plucking block. It can utilize the attractive force between the suspended strong magnet and the static cutter head and the support force between the static cutter head and the movable cutter head to balance, so that the movable cutter head is limitedly slide on the surface of the static cutter head, which improves the strength of the device, enhances the service life, reduces friction, and improves the heating speed of the cutter head.

### RELATED APPLICATIONS

This application claims the benefit of priority to Chinese Patent Application Number 202220057483.9 filed on Jan. 11, 2022. The entire contents of the above. identified application are hereby incorporated by reference.

### TECHNICAL FIELD

The present disclosure relates to the technical field of shaver device, and particularly relates to a magnetic suspension shaver head structure.

### BACKGROUND

Shaver is a kind of small appliance used to remove the body hair.

The shaver cutter head can be divided into static cutter head and movable cutter hea d. Generally, the static cutter head and the movable cutter head are mostly connected by springs, which may break due to material problem during long-term operation, making the service life lo w, and hair is easy to get into the inside of the springs, which is not easy to clean.

### SUMMARY OF THE DISCLOSURE

Regarding to the disadvantages of the prior art, the present disclosure proposes a magnetic suspension shaver head structure to solve the above problems.

The present disclosure provides technical solutions as follow: A magnetic suspended shaver head structure, including: a static cutter head and a shaver body, the upper surface of the shaver body is provided with a positioning slot, the inner wall of the positioning slot is provided with a strong magnetic positioning frame, the two opposite sides of the strong magnetic positioning frame are open with mounting port, and the inner wall of the mounting port is fixedly connected with a suspended strong magnet, the upper surface of the static cutter head is provided with a movable cutter head, the top side of the movable cutter head is fixedly connected with a plucking block, the bottom of the plucking block is integrally connected to a connecting pole.

Preferably, the two opposite sides of the movable cutter head are open with a first connecting hole, the two opposite sides of the strong magnetic positioning frame are open with a second connecting hole, the inner wall of the first connecting hole and the inner wall of the second connecting hole are fixedly connected with the outer wall of the connecting pole.

Preferably, the outer wall of the strong magnetic positioning frame is slidably connected with the inner wall of the positioning slot, and the lower surface of the movable cutter head is fixedly connected with the upper surface of the strong magnetic positioning frame.

Preferably, the two opposite sides of the static cutter head are open with a bolt hole, and the material of the static cutter head is ferromagnetic metal.

Preferably, a transmission shaft is installed on the output end of the shaver body, a plunking slot is embedded in the top of the plunking block, and the inner wall of the plunking slot is slidably connected with the outer wall of the transmission shaft.

Preferably, a supporting block is integrally connected to one side of the movable cutter head, the bottom of the supporting block is slidably connected with the upper surface of the static cutter head.

Comparing with the prior art, the beneficial effects of the present disclosure are as follows:

1. By the provided static cutter head, the shaver body, the positioning slot, the strong magnetic positioning frame, the mounting port, the suspended strong magnet, the movable cutter head, the plucking block and the connecting pole, the magnetic suspended shaver head structure can utilize the attractive force between the suspended strong magnet and the static cutter head and the support force between the static cutter head and the movable cutter head to balance, so that the movable cutter head is limitedly slide on the surface of the static cutter head, which improves the strength of the device, enhances the service life, avoids the installation of springs and other energy storage parts, improves the safety, and simplifies the assembly process.

2. By the provided static cutter head, the positioning slot, the strong magnetic positioning frame, the suspended strong magnet and the movable cutter head, the magnetic suspended shaver head structure reduces health corners, facilitates cleaning of foreign matter and impurities, reduces friction, and improves the heating speed of the cutter head.

### BRIEF DESCRIPTION OF DRAWINGS

Implementations of the present disclosure will now be described, by way of embodiment, with reference to the attached figures.

FIG. 1 is a structure diagram of a magnetic suspension shaver head structure proposed by the present disclosure.

FIG. 2 is a structure diagram of the connection between the static cutter head and the shaver body according to the present disclosure.

FIG. 3 is a side sectional view of the magnetic suspension shaver head structure proposed by the present disclosure.

FIG. 4 is a schematic diagram of an explosion structure of the magnetic suspension shaver head structure proposed by the present disclosure.

FIG. 5 is an enlarged view of portion A in FIG. 2 according to the present invention.

Reference signs in the figures: 1. static cutter head; 2. shaver body; 3. positioning slot; 4. strong magnetic positioning frame; 5. mounting port; 6. suspended strong magnet; 7. movable cutter head; 8. plucking block; 9. connecting pole; 10. first connecting hole; 11. second connecting hole; 12. bolt hole; 13. transmission shaft; 14. plunking slot; 15. supporting block.

### DETAILED DESCRIPTION

The technical scheme in the embodiment of the present disclosure will be clearly and completely described below in combination with the accompanying drawings in the embodiment of the present disclosure. Obviously, the described embodiments are only part of the embodiments of the present disclosure, not all of the embodiments of the present disclosure. Based on the embodiments of the present disclosure, all other embodiments obtained by those skilled in the art without creative efforts belong to the scope of protection of the present invention.

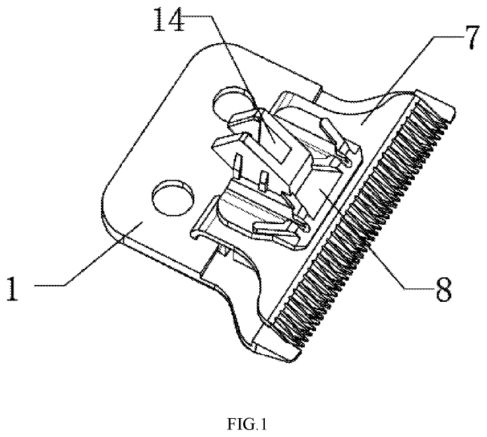

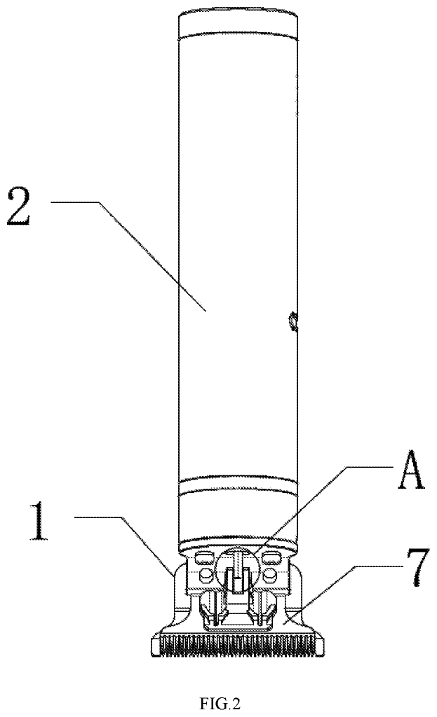

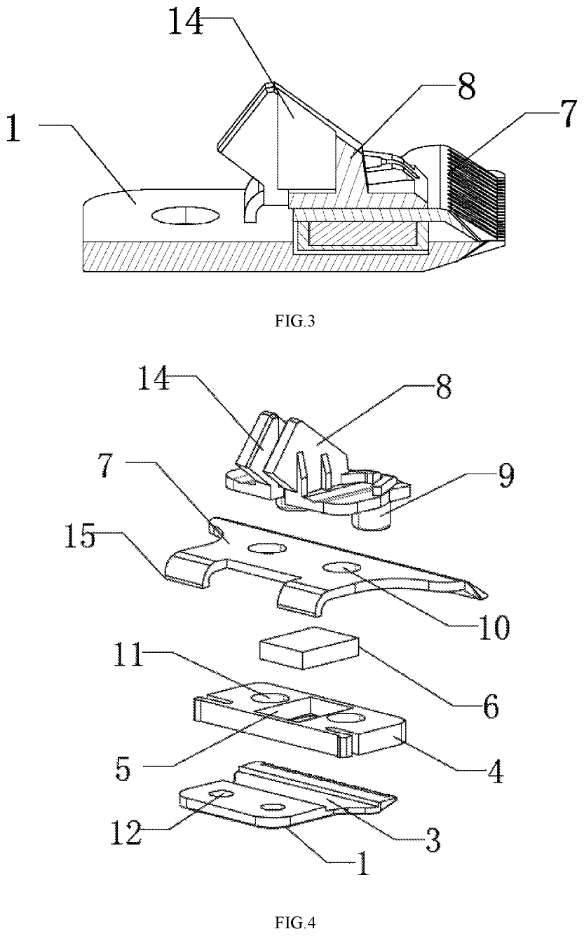

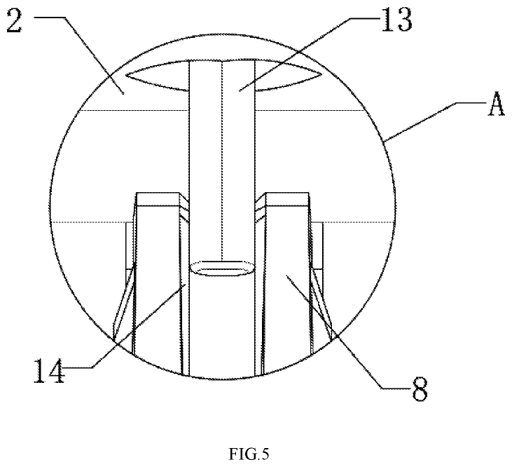

Referring to FIGS. 1-5, a magnetic suspension shaver head structure, including: a static cutter head 1 and a shaver body 2, the upper surface of the shaver body 2 is provided with a positioning slot 3, the inner wall of the positioning slot 3 is provided with a strong magnetic positioning frame 4, the two opposite sides of the strong magnetic positioning frame 4 are open with mounting port 5, and the inner wall of the mounting port 5 is fixedly connected with a suspended strong magnet 6, the maximum magnetic energy product of the suspended strong magnet 6 needs to be above N38, the upper surface of the static cutter head 1 is provided with a movable cutter head 7, the top side of the movable cutter head 7 is fixedly connected with a plucking block 8, the bottom of the plucking block 8 is integrally connected to a connecting pole 9. By the provided static cutter head 1, the shaver body 2, the positioning slot 3, the strong magnetic positioning frame 4, the mounting port 5, the suspended strong magnet 6, the movable cutter head 7, the plucking block 8 and the connecting pole 9, the magnetic suspended shaver head structure can utilize the attractive force between the suspended strong magnet 6 and the static cutter head 1 and the support force between the static cutter head 1 and the movable cutter head 7 to balance, so that the movable cutter head 7 is limitedly slide on the surface of the static cutter head 1, which improves the strength of the device, enhances the service life, avoids the installation of springs and other energy storage parts, improves the safety, and simplifies the assembly process.

Wherein, the two opposite sides of the movable cutter head 7 are open with a first connecting hole 10, the two opposite sides of the strong magnetic positioning frame 4 are open with a second connecting hole 11, the inner wall of the first connecting hole 10 and the inner wall of the second connecting hole 11 are fixedly connected with the outer wall of the connecting pole 9, so that the connecting pole 9 can be used to improve the firmness between the movable cutter head 7 and the strong magnetic positioning frame 4.

Wherein, the outer wall of the strong magnetic positioning frame 4 is slidably connected with the inner wall of the positioning slot 3, and the lower surface of the movable cutter head 7 is fixedly connected with the upper surface of the strong magnetic positioning frame 4. By the provided static cutter head 1, the positioning slot 3, the strong magnetic positioning frame 4, the suspended strong magnet 6 and the movable cutter head 7, the magnetic suspended shaver head structure reduces health corners, facilitates cleaning of foreign matter and impurities, reduces friction, and improves the heating speed of the cutter head.

Wherein, the two opposite sides of the static cutter head 1 are open with a bolt hole 12, and the material of the static cutter head 1 is ferromagnetic metal. Ferromagnetism refers to the magnetic state of a material, which has a spontaneous magnetization phenomenon. Among the materials, iron is the most widely known. After some materials are magnetized under the action of an external magnetic field, even if the external magnetic field disappears, they can still maintain their magnetized state and have magnetism, which is the so-called spontaneous magnetization phenomenon. All permanent magnets are ferromagnetic or ferrimagnetic, ferromagnetic metals are a general term for metals with ferromagnetic properties. The static cutter head 1 made of ferromagnetic metal material is provided, so that the static cutter head 1 and the movable cutter head 7 are connected by the attractive force between the static cutter head 1 and the suspended strong magnet 6.

Wherein, a transmission shaft 13 is installed on the output end of the shaver body 2, a plunking slot 14 is embedded in the top of the plunking block 8, and the inner wall of the plunking slot 14 is slidably connected with the outer wall of the transmission shaft 13, so that the transmission shaft 13 is used to perform a periodic eccentric rotational movement inside the shaver body 2 to plunk the movable cutter head 7 to move left and right on the upper surface of the static cutter head 1.

Wherein, a supporting block 15 is integrally connected to one side of the movable cutter head 7, and the bottom of the supporting block 15 is slidably connected with the upper surface of the static cutter head 1, so as to form a support by the movable cutter head 7 and the supporting block 15, avoiding direct contact between the bottom of the strong magnetic positioning frame 4 with the inner bottom wall of the positioning slot 3 to reduce friction.

Operating principle: When in use, the transmission shaft 13 performs periodic eccentric rotational movement inside the shaver body 2, and the transmission shaft 13 toggles the plunking slot 14, so that the plunking block 8 drives the movable cutter head 7 moving left and right on the upper surface of the static cutter head 1. The transmission shaft 13 forms a limit for the left and right directions of the plunking block 8 inside the plunking slot 14, and the attractive force between the suspended strong magnet 6 and the static cutter head 1 forms a limit for the up and down directions of the static cutter head 1 and the movable cutter head 7. Due to the support of the movable cutter head 7 and the supporting block 15, it avoids direct contact between the bottom of the strong magnetic positioning frame 4 with the inner bottom wall of the positioning slot 3 to reduce friction. The inner wall of the positioning slot 3 forms a guide position to the outer wall of the strong magnetic positioning frame 4, which ensures that the movable cutter head 7 moves along the positioning slot 3. Thus, the dislocation between the movable cutter head 7 and static cutter head 1 is utilized to form a cut.

The above is only the preferred specific embodiment of the present disclosure, but the protection scope of the present disclosure is not limited to this. Any technician familiar with the technical field who makes equivalent replacement or modification according to the technical scheme and inventive concept of the present disclosure within the technical scope disclosed by the present disclosure shall be covered by the protection scope of the present disclosure.

What is claimed is:

1. A magnetic suspension shaver head structure, comprising:
a static cutter head (1) and a shaver body (2), the upper surface of the shaver body (2) is provided with a positioning slot (3), the inner wall of the positioning slot (3) is provided with a strong magnetic positioning frame (4), the two opposite sides of the strong magnetic positioning frame (4) are open with mounting port (5), and the inner wall of the mounting port (5) is fixedly connected with a suspended strong magnet (6), the upper surface of the static cutter head (1) is provided with a movable cutter head (7), the top side of the movable cutter head (7) is fixedly connected with a plucking block (8), the bottom of the plucking block (8) is integrally connected to a connecting pole (9).

2. The magnetic suspension shaver head structure according to claim 1, wherein
the two opposite sides of the movable cutter head (7) are open with a first connecting hole (10), the two opposite sides of the strong magnetic positioning frame (4) are open with a second connecting hole (11), the inner wall of the first connecting hole (10) and the inner wall of the second connecting hole (11) are fixedly connected with the outer wall of the connecting pole (9).

3. The magnetic suspension shaver head structure according to claim 1, wherein
the outer wall of the strong magnetic positioning frame (4) is slidably connected with the inner wall of the positioning slot (3), and the lower surface of the movable cutter head (7) is fixedly connected with the upper surface of the strong magnetic positioning frame (4).

4. The magnetic suspension shaver head structure according to claim 1, wherein
the two opposite sides of the static cutter head (1) are open with a bolt hole (12), and the material of the static cutter head (1) is ferromagnetic metal.

5. The magnetic suspension shaver head structure according to claim 1, wherein
a transmission shaft (13) is installed on the output end of the shaver body (2), a plunking slot (14) is embedded in the top of the plunking block (8), and the inner wall of the plunking slot (14) is slidably connected with the outer wall of the transmission shaft (13).

6. The magnetic suspension shaver head structure according to claim 1, wherein
a supporting block (15) is integrally connected to one side of the movable cutter head (7), the bottom of the supporting block (15) is slidably connected with the upper surface of the static cutter head (1).
